(19) United States
(12) Patent Application Publication
(10) Pub. No.: US 2010/0320643 A1
(43) Pub. Date: Dec. 23, 2010

(54) REEL

(75) Inventor: Ren ISHIKAWA, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/852,906

(22) Filed: Aug. 9, 2010

Related U.S. Application Data
(62) Division of application No. 11/877,265, filed on Oct. 23, 2007.

(30) Foreign Application Priority Data
Oct. 23, 2006 (JP) 2006-287444

(51) Int. Cl. B29C 45/40; B29C 45/14

(52) U.S. Cl. 264/259; 425/236

(57) ABSTRACT

A reel comprising: a hub on which a recording tape is wound; and a pair of flanges provided at both end portions of the hub respectively, and holding transverse direction end portions of the recording tape, wherein the hub is reinforced by a reinforcing ring, and at a time of release from a mold which molds the hub, an entire region of an end surface of the reinforcing ring is pushed, is provided.

This application is a divisional application of U.S. application Ser. No. 11/877,265, filed Oct. 23, 2007, which claims priority to JP 2006-287444, filed Oct. 23, 2006, each of which is incorporated herein by reference in this entirety.

### BACKGROUND

1. Technical Field

The present invention relates to a reel on which is wound a recording tape, such as a magnetic tape or the like, which is used as a recording/playback medium mainly of computers or the like.

2. Related Art

For example, recording tape cartridges, which accommodate within a case a reel on which a magnetic tape is wound, are known as external recording media of computers and the like. The reel has a hub, which structures the axially central portion of the reel and on whose outer periphery a magnetic tape is wound, and an upper flange and a lower flange, which project-out outwardly in the radial direction from the axial direction both ends of the hub respectively.

There have conventionally been known recording tape cartridges in which a recording tape, such as a magnetic tape or the like which is used as a data recording/playback medium of a computer or the like, is wound on a single reel, and the reel is rotatably accommodated within a case made of a synthetic resin. A leader member, such as a leader pin, a leader tape, or a leader block, is provided at the distal end (free end) of the recording tape. A pull-out means provided at a drive device side pulls the leader member out from an opening of the recording tape cartridge, and winds the recording tape fixed thereto onto a take-up reel of the drive device side.

At the reel of such a recording tape cartridge, the recording tape is usually wound on the outer peripheral surface of the hub. The upper flange and the lower flange are provided at the top and bottom of the hub respectively. The upper and lower flanges restrict the heightwise position of the recording tape in the vertical direction, hold the recording tape such that the wound posture thereof is good so as to improve the running stability, and further, prevent excessive damage at the time when the recording tape cartridge is not in use.

On the other hand, it is often the case that the hub is formed in the shape of a cylindrical tube having a floor, in which one side in the axial direction is open and the other side is closed. At a hub which is formed in such a shape of the cylindrical tube having a floor, it is easy for the open end side thereof, which has low strength, to deform due to the winding pressure of the magnetic tape. In this way, if the hub deforms, the flange provided at the open end side of the hub deforms in a direction of contacting a transverse direction end portion (edge) of the magnetic tape.

Therefore, structures have been thought of which reinforce the hub with a metal ring in order to prevent deformation of the hub, such as in Japanese Patent Applications Laid-Open (JP-A) Nos. 2004-14022 and 2005-116163 for example. In this way, if the outer peripheral surface of the metal ring is covered by resin and the metal ring and the resin are made integral by insert molding, because there is little heat shrinkage of the metal ring which is different than as is the case with resin, it is difficult for the molded product to bite-into the core side (the movable side), and the problem of so-called cavity removal defect arises.

Therefore, the mold release resistance of the molded product from the core side is made to be higher than that at the cavity side, and the molded product is made to bite-into the core side. However, when releasing the molded product from the core side, the pushing force from ejecting pins which are for releasing the molded product becomes large by an amount corresponding to the amount by which the mold release resistance is made large.

Further, there is the concern that, in the ejecting step, deformation or cracking of the metal ring will arise due to the concentration of stress at the metal ring which is due to the pushing of the ejecting pins.

### SUMMARY

In view of the aforementioned, an object of the present invention is to provide a reel in which the rigidity of a hub is improved and which can suppress the occurrence of deformation and cracking of the hub.

In order to achieve the above object, a first aspect of the present invention is a reel having: a hub on which a recording tape is wound; and a pair of flanges provided at both end portions of the hub respectively, and holding transverse direction end portions of the recording tape, wherein the hub is reinforced by a reinforcing ring, and at a time of release from a mold which molds the hub, an entire region of an end surface of the reinforcing ring is pushed.

In the first aspect, by reinforcing the hub by the reinforcing ring, the rigidity of the hub is improved. At the time of release from the mold which molds the hub, the entire region of the end surface of the reinforcing ring is pushed. In this way, large stresses are not applied locally at the end surface of the reinforcing ring, and the occurrence of deformation or cracking of the reinforcing ring is suppressed.

As described above, in accordance with the present invention, the rigidity of the hub is improved, and further, the occurrence of deformation and cracking of the hub can be suppressed.

### BRIEF DESCRIPTION OF THE DRAWINGS

An exemplary embodiment of the present invention will be described in detail based on the following figures, wherein:

FIG. 1A is a schematic perspective view when viewing, from above, a recording tape cartridge relating to the exemplary embodiment of the present invention;

FIG. 1B is a schematic perspective view when viewing, from below, the recording tape cartridge relating to the exemplary embodiment of the present invention;

FIG. 2 is a schematic sectional view at the time when a reel of the recording tape cartridge relating to the exemplary embodiment of the present invention is at a rotation locked position;

FIG. 3 is a schematic sectional view at the time when the reel of the recording tape cartridge relating to the exemplary embodiment of the present invention is at a rotation permitted position;

FIG. 4 is a schematic exploded perspective view when viewing, from above, the reel of the recording tape cartridge relating to the exemplary embodiment of the present invention;

FIG. 5 is a schematic exploded perspective view when viewing, from below, the reel of the recording tape cartridge relating to the exemplary embodiment of the present invention;

FIG. 6 is a schematic plan view of an upper flange and a reel hub of the recording tape cartridge relating to the exemplary embodiment of the present invention;

FIG. 7 is a schematic bottom view of the upper flange and the reel hub of the recording tape cartridge relating to the exemplary embodiment of the present invention;

FIG. 8 is a schematic plan view of a lower flange of the recording tape cartridge relating to the exemplary embodiment of the present invention;

FIG. 9 is a schematic bottom view of the lower flange of the recording tape cartridge relating to the exemplary embodiment of the present invention;

FIG. 10 is a schematic exploded sectional view of the reel of the recording tape cartridge relating to the exemplary embodiment of the present invention;

FIG. 11 is a schematic sectional view of the reel of the recording tape cartridge relating to the exemplary embodiment of the present invention;

FIG. 12 is a schematic sectional view showing a state in which a mold, which molds the reel hub and the upper flange of the recording tape cartridge relating to the exemplary embodiment of the present invention, is opened;

FIG. 13 is a schematic sectional view showing a state in which the mold, which molds the reel hub and the upper flange of the recording tape cartridge relating to the exemplary embodiment of the present invention, is closed;

FIG. 14 is a schematic sectional view showing a state in which the mold, which molds the reel hub and the upper flange of the recording tape cartridge relating to the exemplary embodiment of the present invention, is closed and resin is filled therein;

FIG. 15 is a schematic sectional view showing a state in which the mold, which molds the reel hub and the upper flange of the recording tape cartridge relating to the exemplary embodiment of the present invention, is opened;

FIG. 16 is a schematic sectional view showing a state in which the mold, which molds the reel hub and the upper flange of the recording tape cartridge relating to the exemplary embodiment of the present invention, is opened and a molded product is ejected;

FIG. 17 is an explanatory diagram explaining a conventional problematic point;

FIG. 18 is an explanatory diagram explaining a conventional problematic point;

FIG. 19 is a schematic perspective view showing the molded product, and an ejecting sleeve of the mold which molds the reel hub and the upper flange of the recording tape cartridge relating to the exemplary embodiment of the present invention;

FIG. 20 is a schematic perspective view corresponding to FIG. 17 and showing the molded product which is molded in the mold which molds the reel hub and the upper flange of the recording tape cartridge relating to the exemplary embodiment of the present invention;

FIG. 21 is a schematic exploded sectional view showing a first modified example of the structure of the reel of the recording tape cartridge relating to the exemplary embodiment of the present invention; and

FIG. 22 is a schematic exploded sectional view showing a second modified example of the structure of the reel of the recording tape cartridge relating to the exemplary embodiment of the present invention.

### DETAILED DESCRIPTION

A preferred form which embodies the present invention will be described in detail hereinafter on the basis of the exemplary embodiment shown in the drawings. First, the schematic structure of a recording tape cartridge 10 will be described. Note that, for convenience of explanation, the direction of loading the recording tape cartridge 10 into a drive device is denoted by arrow A, and this direction of arrow A is set to be the forward direction (front side) of the recording tape cartridge 10. A direction orthogonal to the direction of arrow A is denoted by arrow B, and this direction of arrow B is set to be the rightward direction (right side) of the recording tape cartridge 10.

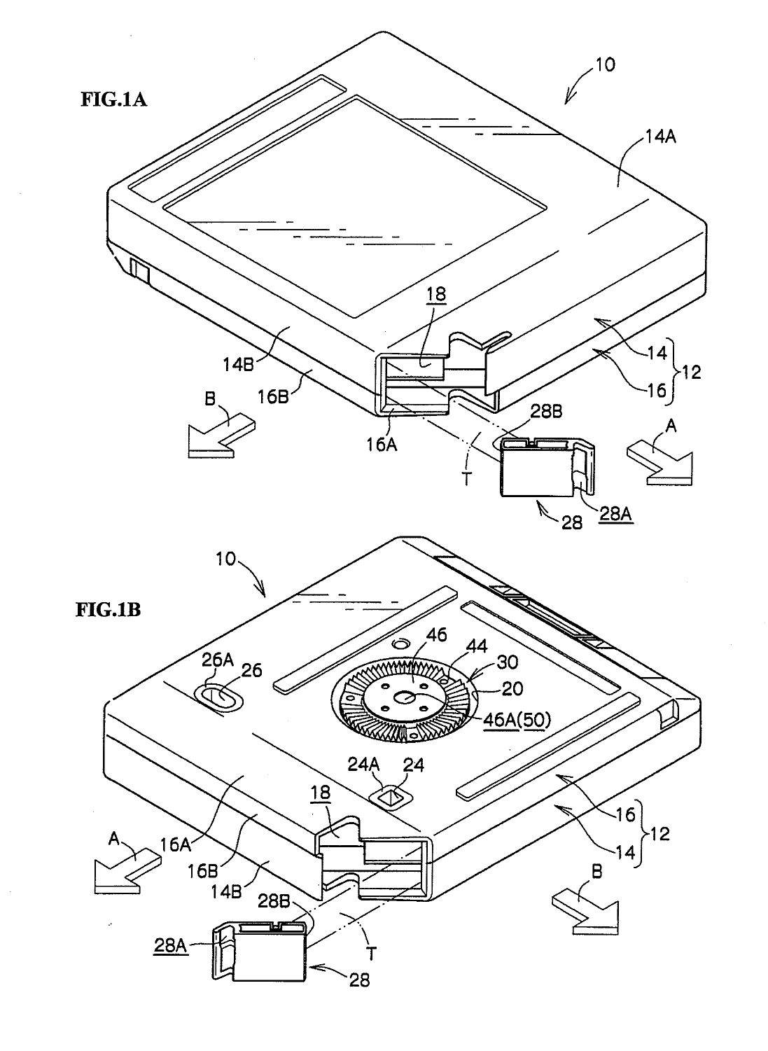

As shown in FIG. 1 through FIG. 3, the recording tape cartridge 10 has a case 12. The case 12 is structured by an upper case 14 and a lower case 16 being joined together. Specifically, the upper case 14 is structured such that a substantially frame-shaped peripheral wall 14B stands erect along the outer edge of a ceiling plate 14A which is substantially rectangular in plan view. The lower case 16 is structured such that a substantially frame-shaped peripheral wall 16B stands erect along the outer edge of a floor plate 16A which has a configuration substantially corresponding to that of the ceiling plate 14A. The case 12 is formed substantially in the shape of a rectangular box by the upper case 14 and the lower case 16 being joined together by ultrasonic welding or screws or the like in a state in which the open end of the peripheral wall 14B and the open end of the peripheral wall 16B abut one another.

At a corner portion of the case 12 at the leading side in the direction of loading the recording tape cartridge 10 into the drive device, the ceiling plate 14A, the peripheral wall 14B, the floor plate 16A, and the peripheral wall 16B are respectively cut-out such that an opening 18, which is inclined with respect to the direction of loading, is formed. Further, a circular gear opening 20 which passes through the floor plate 16A is provided in the substantially central portion of the floor plate 16A, and is for exposing a reel gear 44 which will be described later. At the edge portion of the gear opening 20 at the floor plate 16A, an annular rib 22 projects toward the inner side of the case 12, and is for positioning a reel 30 which will be described later and for dust-proofing.

A pair of positioning holes 24, 26 open in a vicinity of the front end of the outer surface of the floor plate 16A of the case 12. The pair of positioning holes 24, 26 are provided in the form of pockets within protruding portions (not shown) which stand erect from the floor plate 16A toward the inner side of the case 12. The positioning holes 24, 26 are disposed to be spaced apart from one another on an imaginary line in the direction of arrow B. The positioning hole 24, which is at the side closer to the opening 18, is formed, in bottom view, substantially in the shape of a square which circumscribes a positioning pin (not shown) of the drive device. The positioning hole 26 is formed as a long hole which is long along the aforementioned imaginary line and whose width corresponds to the diameter of a positioning pin. Accordingly, when the recording tape cartridge 10 is loaded into the drive device and positioning pins are inserted into the positioning holes 24, 26 respectively, the recording tape cartridge 10 is positioned accurately in the horizontal direction (the left/right direction and front/back direction) within the drive device.

The portions of the floor plate 16A around the positioning holes 24, 26 are reference surfaces 24A, 26A which are finished so as to be smoother than the other portions (the design surface) of the floor plate 16A. When the positioning pins are inserted into the positioning holes 24, 26, the reference surfaces 24A, 26A abut reference surfaces (not shown) of the drive device which are provided around the positioning pins. In this way, the vertical direction positioning of the recording tape cartridge 10 within the drive device is carried out.

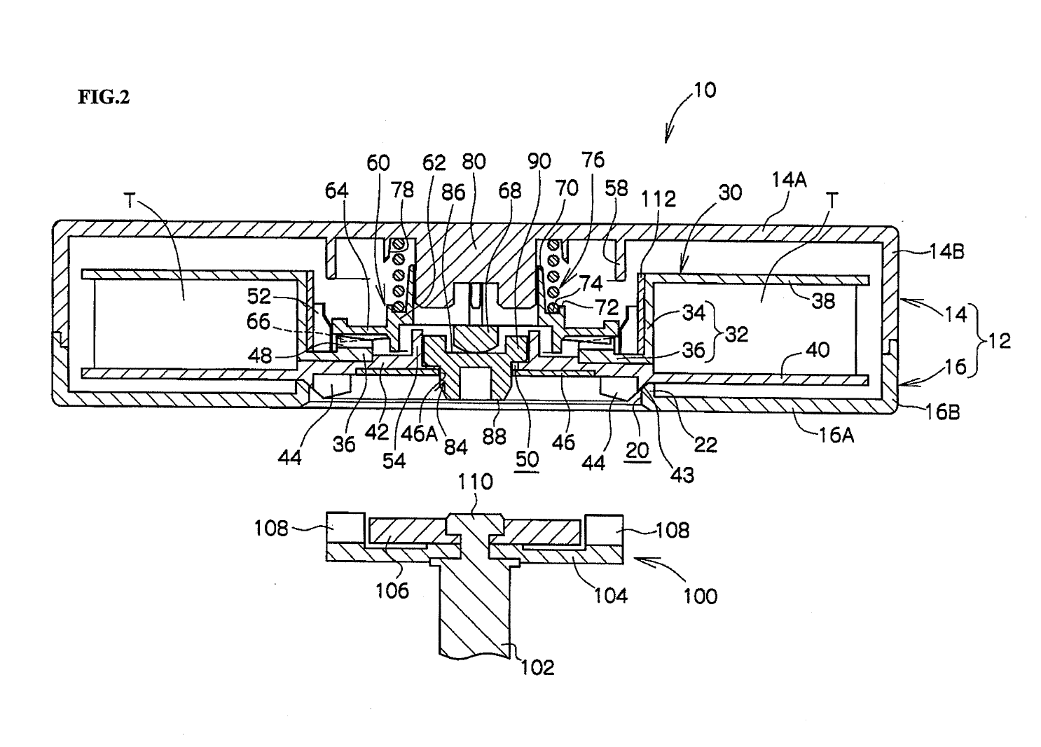

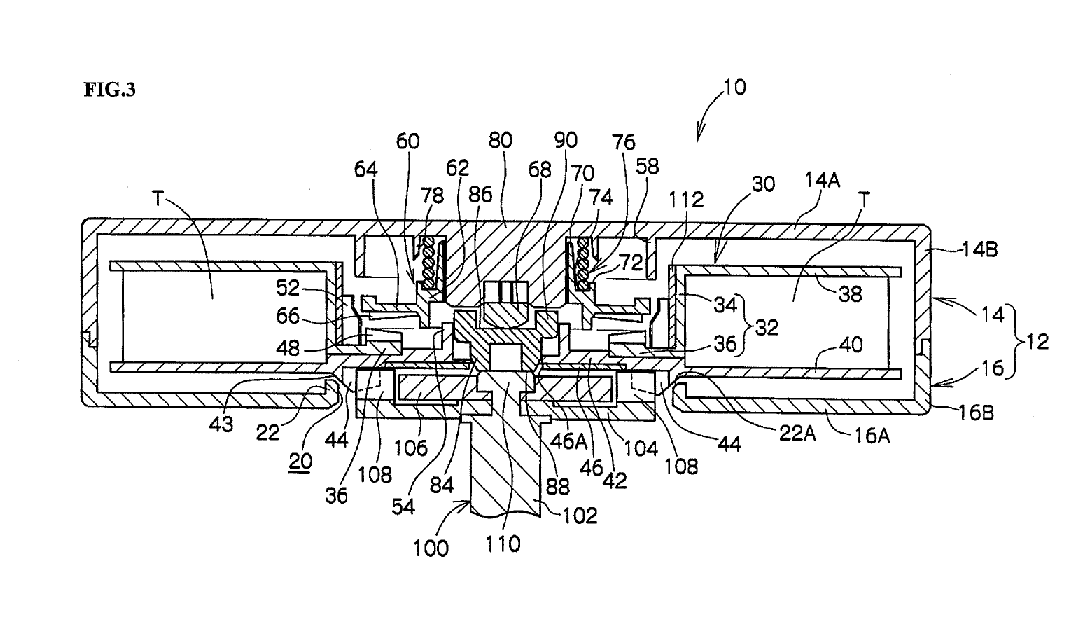

As shown in FIG. 2 and FIG. 3, only one of the reel 30, which will be described later, is rotatably accommodated in the case 12. A recording tape T, such as a magnetic tape or the like, is wound on the reel 30. As shown in FIG. 1, a leader block 28 serving as a leader member is attached to the distal end of the recording tape T. When the recording tape cartridge 10 is not being used, the leader block 28 is accommodated and held at the inner side of the opening 18 of the case 12. In this state, the leader block 28 closes the opening 18 and impedes entry of dust and the like into the case 12.

An engaging recess 28A is formed in the distal end of the leader block 28. When the recording tape T is to be pulled-out within the drive device, the leader block 28 is taken-out from the case 12 by a pull-out means (not shown) which engages with the engaging recess 28A, and is guided to a take-up reel (not shown) of the drive device. Moreover, the end surface of the leader block 28 at the side opposite the engaging recess 28A is an arc-shaped surface 28B. By being fit-into the reel hub of the take-up reel, the arc-shaped surface 28B forms a portion of the take-up surface on which the recording tape T is taken-up.

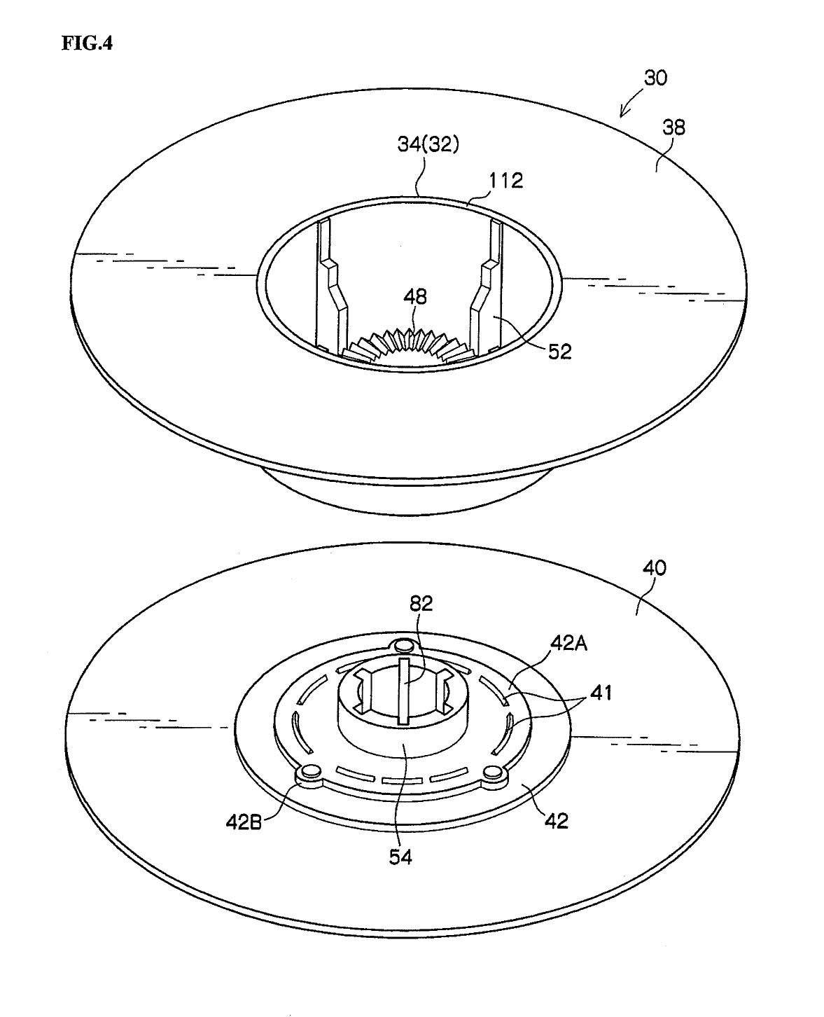

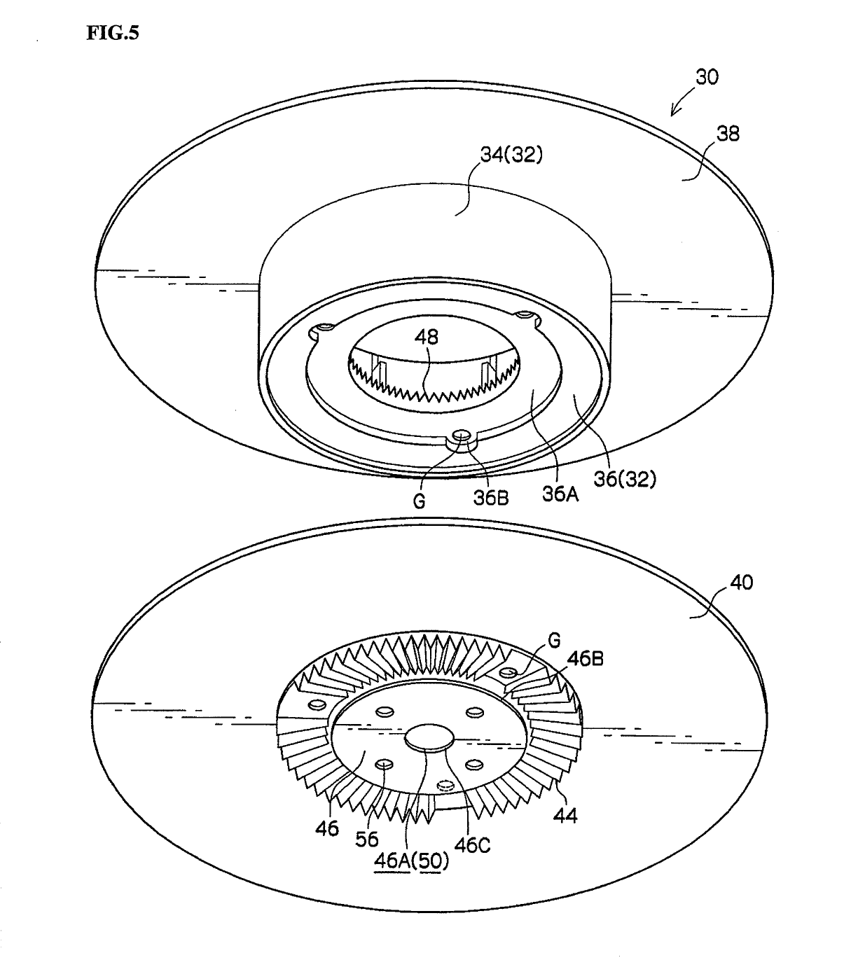

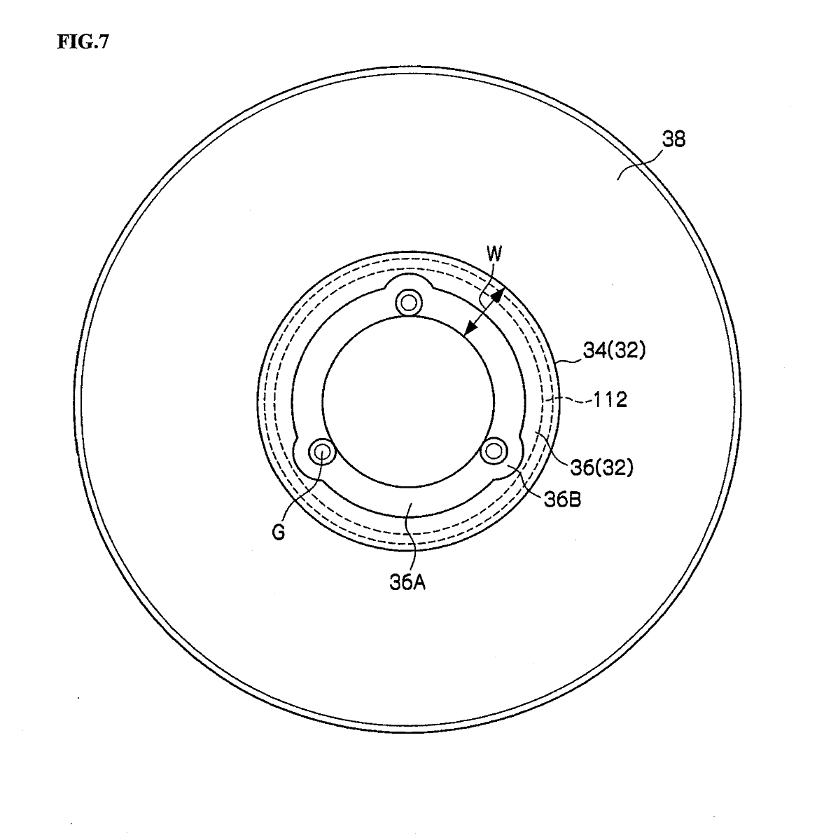

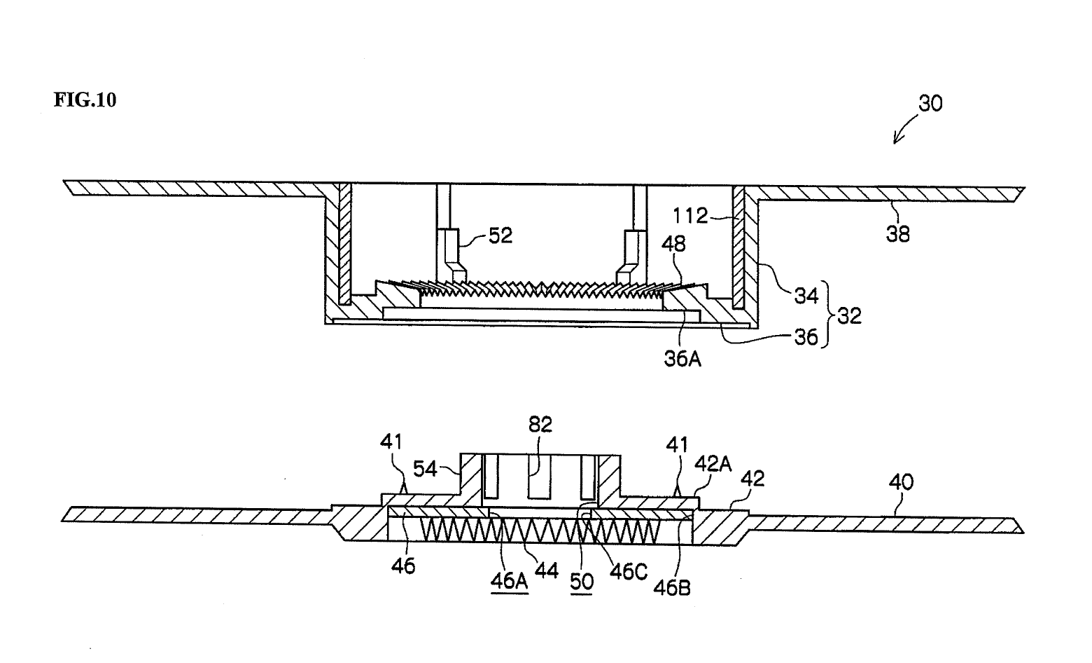

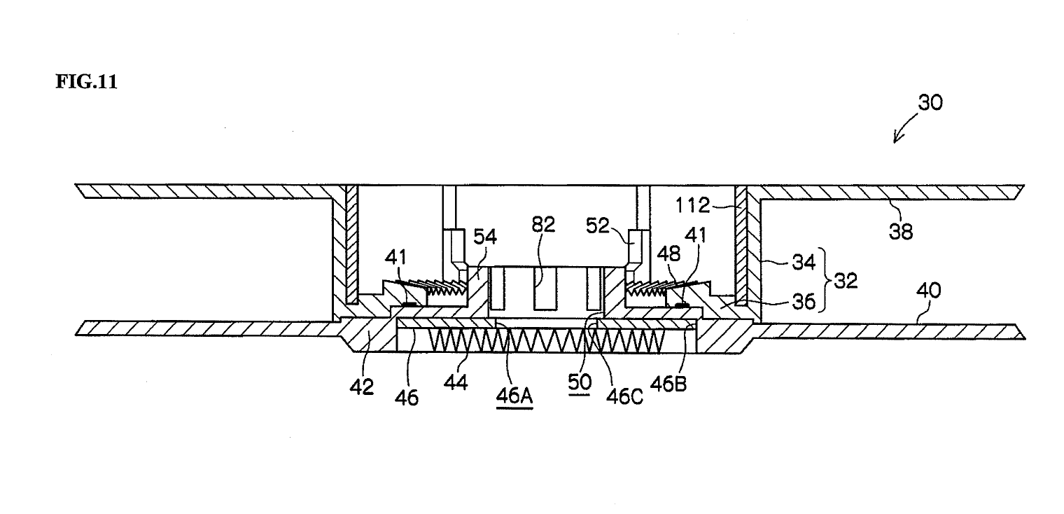

Next, the reel 30 and a braking means, which impedes rotation of the reel 30 when not in use, will be described. As shown in FIG. 4 through FIG. 7 and in FIG. 10 and FIG. 11, the reel 30 has a reel hub 32 which structures the axially central portion thereof. The reel hub 32 has a cylindrical tube portion 34, which has a wall thickness of 1.0 mm and around whose outer peripheral surface the recording tape T is wound, a metal ring (reinforcing ring) 112, which is made of aluminum and has a wall thickness of 1.0 mm and is insert-molded at the inner peripheral surface of the cylindrical tube portion 34, and an annular extending portion 36, which is provided integrally at the bottom end portion of the cylindrical tube portion 34 so as to extend in an annular form by a predetermined width toward the center of the cylindrical tube portion 34. Note that a width W (see FIG. 7) of the annular extending portion 36 is an extent such that an engaging gear 48 and a standing rib 52, which will be described later, can be formed.

An annular concave portion 36A serving as an engaged portion is formed to a predetermined depth at the bottom surface of the annular extending portion 36 and the central side of the reel hub 32. Note that plural (three in the illustrated structure) expandingly-opening concave portions 36B, whose surface areas open expandingly in circular-arc shapes in the radial direction, are formed so as to be separated from one another at predetermined intervals at the annular concave portion 36A. Gates G, which are fill openings for a resin material of a mold (not shown) which molds the reel hub 32 and an upper flange 38, are formed at the expandingly-opening concave portions 36B. Further, the upper flange 38 is provided coaxially and integrally at the edge of the top end portion of the reel hub 32, so as to extend toward the radial direction outer side. Namely, the reel hub 32 and the upper flange 38 are molded integrally from a resin material.

On the other hand, a lower flange 40, to which is fixed a reel plate 46 which is made of metal and will be described later, is joined (welded) to the bottom end portion of the reel hub 32. As shown in FIG. 4 and FIG. 5 and FIG. 8 through FIG. 11, the outer diameter of the lower flange 40 is the same as the outer diameter of the upper flange 38. A floor wall 42, which is substantially the same diameter as the reel hub 32, is formed at the axially central portion of the lower flange 40.

An annular convex portion 42A, which serves as an engaging portion which engages with the annular concave portion 36A, is formed to a predetermined height at the top surface of the floor wall 42. Plural (three in the illustrated structure) expandingly-opening convex portions 42B, which fit-together with the expandingly-opening concave portions 36B, are formed so as to be separated from one another at predetermined intervals at the annular convex portion 42A.

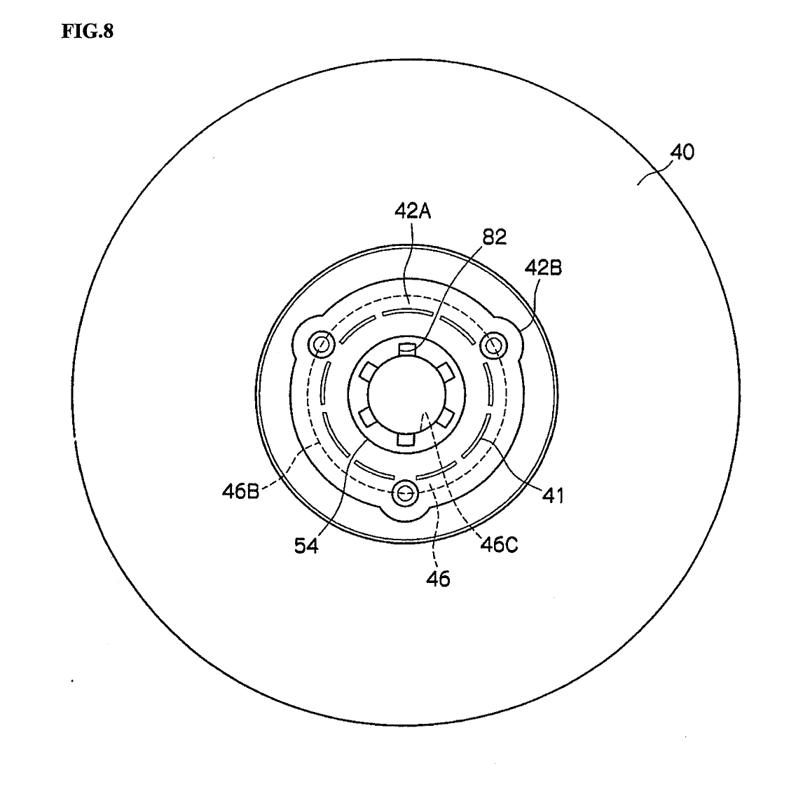

Further, as shown in FIG. 8 through FIG. 11, plural (nine in the illustrated structure) energy directors (hereinafter called “EDs”) 41, which are ribs for welding, project-out at uniform intervals at the top surface of the annular convex portion 42A within a region where the reel plate 46 exists (between an outer peripheral edge portion 46B and an inner peripheral edge portion 46C).

Accordingly, at the time of welding the lower flange 40 to the bottom surface of the annular extending portion 36 of the reel hub 32, the expandingly-opening concave portions 36B and the expandingly-opening convex portions 42B are fit-together, and the annular concave portion 36A and the annular convex portion 42A are fit-together, and the EDs 41 are melted by ultrasonic waves generated from an unillustrated horn.

In this way, the annular concave portion 36A and the annular convex portion 42A can be welded while the lower flange 40 (the reel gear 44 which will be described later) is positioned with respect to the reel hub 32. The recording tape T can be wound around the outer peripheral surface of the cylindrical tube portion 34 of the reel hub 32 between the opposing surfaces of the upper flange 38 and the lower flange 40.

In this way, the EDs 41 are provided at the top surface of the annular convex portion 42A within the region where the reel plate 46 exists. By interposing the metal reel plate 46 directly beneath the place where the reel hub 32 (the annular concave portion 36A) and the lower flange 40 (the annular convex portion 42A) are joined together (i.e., directly beneath the welded region), deformation due to tight-winding of the recording tape T can be suppressed at the reel plate 46.

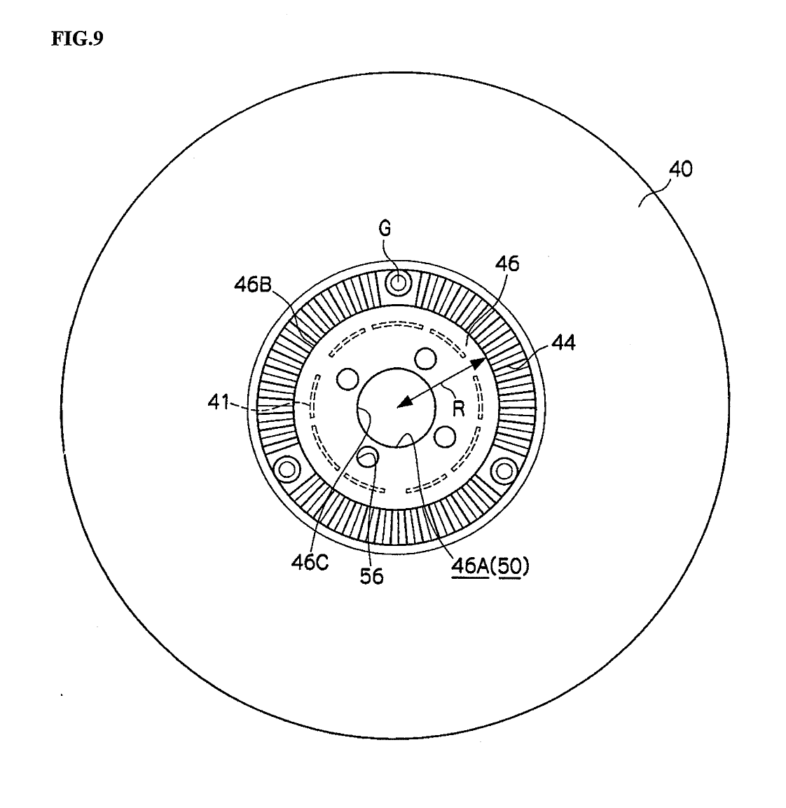

Further, as shown in FIG. 9, the reel gear 44, which is formed in an annular shape which is coaxial with the reel hub 32 at the time when the reel gear 44 is joined to the reel hub 32, is formed at the bottom surface (outer surface) of the floor wall 42 at the lower flange 40. The reel gear 44 can mesh-together with a driving gear 108 which is provided at the distal end of a rotating shaft 100 of the drive device shown in FIG. 2 and FIG. 3.

The tooth crests of the reel gear 44 project-out further downward than the bottom surface of the lower flange 40, and the tooth bottoms are positioned further upward than the bottom surface of the lower flange 40. The radial direction outer end portions of the respective teeth are connected by a taper portion 43 which is continuous with the lower flange 40 from the central portions in the heightwise direction of the teeth to the tooth bottoms thereof. A plurality (three in the illustrated structure) of the gates G, which are fill openings for a resin material of a mold (not shown) which molds the lower flange 40, are formed at predetermined positions on the reel gear 44.

The reel plate 46, which is an annular metal plate formed of a magnetic material, is fixed coaxially and integrally to the floor wall 42 of the lower flange 40 by insert molding, at the inner side of the reel gear 44. Accordingly, plural (four in the illustrated structure) small holes 56, which have step portions into which the resin material flows and stops, are formed in the reel plate 46.

A pass-through hole 50, through which a clutch member 84 which will be described later is inserted, is formed in the center (the axially central portion) of the floor wall 42 at the lower flange 40. A boss portion 54 for the clutch, which is shaped as a short cylindrical tube and serves as a guide wall portion, stands erect upwardly along the edge portion of the pass-through hole 50. The boss portion 54 for the clutch will be described together with the clutch member 84 which will be described later. Note that the axially central portion of the reel plate 46 is a through-hole 46A. As shown in FIG. 10 and FIG. 11, the inner diameter of the through-hole 46A is formed to be slightly smaller than the inner diameter of the pass-through hole 50.

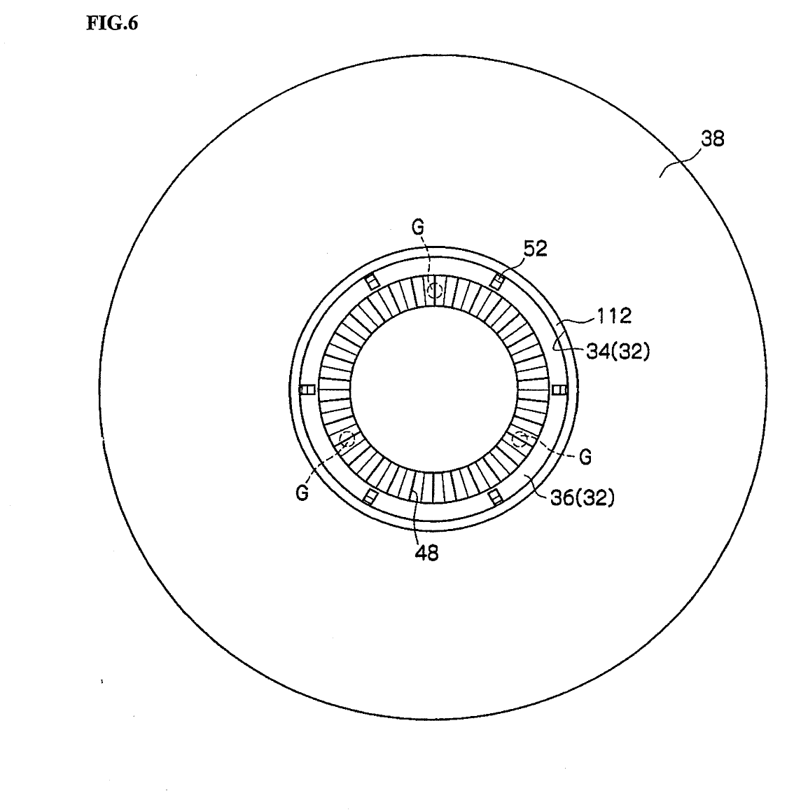

As shown in FIG. 6, the engaging gear 48, which is shaped as a ring which is coaxial with the reel hub 32, is formed at the top surface of the annular extending portion 36 which is formed at the reel hub 32. The engaging gear 48 can mesh-together with a braking gear 66 of a brake member 60 which will be described later. Plural (six in the illustrated structure) standing ribs 52, which are continuous with the inner surface of the metal ring 112 and the top surface of the annular extending portion 36 along the axial direction of the reel 30, are provided at uniform intervals in the peripheral direction at the radial direction outer side of the engaging gear 48. Due to the existence of these standing ribs 52, the engaging gear 48 is positioned further toward the radial direction inner side than the reel gear 44. Note that the standing ribs 52 will be described later together with the brake member 60.

As shown in FIG. 2 and FIG. 3, the reel 30 is accommodated in the case 12 and is placed on the annular rib 22 when not in use. Specifically, radial direction movement of the reel 30 is restricted due to the outer side portion of the taper portion 43 at the floor wall 42 abutting the top end surface of the annular rib 22, and the inner edge portion of the upper end of the annular rib 22 being made to be a taper surface 22A which corresponds to the taper portion 43. This is a structure which deters entry of dust and the like therefrom.

In this state, the reel 30 overall is positioned within the case 12, and the reel gear 44 and the reel plate 46 are exposed from the gear opening 20 (see FIG. 1B). Namely, the reel gear 44 does not project-out from the outer surface (bottom surface) of the floor plate 16A, but faces the exterior of the case 12 from the gear opening 20. Further, the pass-through hole 50 faces the gear opening 20 through the through-hole 46A of the reel plate 46.

In this way, operation of the reel 30, i.e., chucking (holding) and driving/rotating, are possible from the exterior of the case 12. Further, in this state, an annular restricting rib 58, which stands erect from the ceiling plate 14A, is disposed in the upper portion of the metal ring 112 of the reel 30. The outer peripheral surface of the restricting rib 58 is adjacent to the inner peripheral surface of the metal ring 112 (the reel hub 32), such that the restricting rib 58 prevents joggling of the reel 30 within the case 12.

Further, the recording tape cartridge 10 has the brake member 60 which serves as a braking means which impedes rotation of the reel 30 at times when the recording tape cartridge 10 is not in use. The brake member 60 has a base portion 62. The base portion 62 is formed substantially in the shape of a cylindrical tube having a floor which opens downward. A flat plate portion 64, which is formed in an annular shape, extends outwardly in the radial direction over the entire periphery, from the axial direction intermediate portion of the outer peripheral portion of the base portion 62. The braking gear 66 is provided over the entire periphery at the bottom surface of the flat plate portion 64. Namely, the braking gear 66 is formed overall in an annular shape, and can mesh-together with the engaging gear 48 of the reel 30.

A sliding-contact projecting portion 68 projects-out at the axially central portion of the bottom surface of the base portion 62. The distal end portion of the sliding-contact projecting portion 68 is formed to be substantially spherical, and substantially point-contacts the clutch member 84 which will be described later. On the other hand, a cross-shaped projection 70, at whose interior is formed a groove which is substantially cross-shaped as seen in plan view, stands erect at the top surface of the base portion 62. Further, an annular rib 72 stands erect at the top surface of the base portion 62. The top surface of the base portion 62 between the rib 72 and the cross-shaped projection 70 is a spring receiving surface 74 which is abutted by one end portion of a compression coil spring 76 which will be described later.

This brake member 60 is substantially coaxially inserted within the metal ring 112 of the reel hub 32, so as to be movable in the vertical direction (the axial direction of the reel 30). Namely, due to the brake member 60 moving in the vertical direction, the brake member 60 can assume a position (rotation locked position), at which the braking gear 66 thereof meshes-together with the engaging gear 48 of the reel hub 32, and a position (rotation permitted position) at which this meshing-together is released.

A cross-shaped rib 80, which projects downward from the ceiling plate 14A of the case 12, is disposed within the groove of the cross-shaped projection 70 of the brake member 60. The cross-shaped rib 80 is shaped as a detent in which two thin plate pieces intersect one another orthogonally. Due to the cross-shaped rib 80 engaging with the groove walls of the cross-shaped projection 70, rotation of the brake member 60 with respect to the case 12 is impeded. Accordingly, the brake member 60 can impede rotation of the reel 30, in the state in which the braking gear 66 of the brake member 60 is meshed-together with the engaging gear 48 of the reel hub 32.

Note that the state in which the cross-shaped rib 80 is disposed within the groove is maintained over the entire vertical direction moving stroke of the brake member 60, and the cross-shaped rib 80 also functions to guide the direction of movement of the brake member 60 in the vertical direction. Further, the brake member 60 is structured such that, when the brake member 60 is positioned at the rotation locked position, radial direction movement thereof is restricted by the standing rib 52 of the reel 30, and, when the brake member 60 is positioned at the rotation permitted position, the brake member 60 does not interfere with the standing rib 52 which rotates together with the reel 30.

Namely, the upper portion of the standing rib 52 is cut-out such that the standing rib 52 is positioned adjacent to the outer peripheral edge of the flat plate portion 64 of the brake member 60 which is positioned at the rotation locked position, and such that an interval between the standing rib 52 and the brake member 60 which is positioned at the rotation permitted position becomes greater than or equal to a predetermined value. In this way, not only is movement of the reel 30 directly restricted by the case 12, but also, in a vicinity of the position of the center of gravity thereof, radial direction movement of the reel 30 with respect to the case 12 is restricted via the brake member 60. The recording tape cartridge 10 can be stably loaded even into the drive device which is disposed vertically (with the axis of the reel 30 being horizontal).

The compression coil spring 76, which can be interpreted in a broad sense as an urging means, is disposed between the ceiling plate 14A and the spring receiving surface 74 of the brake member 60. One end portion of the compression coil spring 76 abuts the spring receiving surface 74, and the other end portion thereof abuts the ceiling plate 14A. This other end portion is positioned at the inner side of an annular wall portion 78, which projects-out at the ceiling plate 14A at the outer side of the cross-shaped rib 80, such that the position of this other end portion does not become offset in the radial direction.

Due to the urging force of the compression coil spring 76, the brake member 60 is urged downward, and usually causes the braking gear 66 to mesh-together with the engaging gear 48 and reliably prevents inadvertent rotation of the reel 30 (the brake member 60 is positioned at the rotation locked position). Further, due to this urging force, the reel 30, which is meshed-together with the brake member 60 at the engaging gear 48, also is urged downward and abuts the annular rib 22 so as to not joggle within the case 12.

The recording tape cartridge 10 has the clutch member 84 serving as a releasing member which is operated from the exterior when the locked state of the reel 30 by the brake member 60 is to be released. Accompanying the operation of the reel gear 44 meshing-together with the driving gear 108 of the drive device, the clutch member 84 is pushed by a releasing projection 110 of the drive device, which will be described later, so as to move upward, and is disposed between the floor wall 42 of the reel 30 and the brake member 60.

Namely, the clutch member 84 is substantially formed in the shape of a solid cylinder which is inserted through the through-hole 46A and the pass-through hole 50. The outer diameter of the clutch member 84 is slightly smaller than the inner diameter of the through-hole 46A of the reel plate 46, i.e., the pass-through hole 50 which coincides with the inner diameter of the boss portion 54 for the clutch. Further, the flat top end surface of the axially central portion of the clutch member 84 is a sliding-contact surface 86 which always abuts the sliding-contact projecting portion 68 of the brake member 60. The flat bottom end surface of the clutch member 84, which is around a lightening hole provided so as to open downward, is a pushing/operating surface 88. Accordingly, when the pushing/operating surface 88 of the clutch member 84 is pushed, the clutch member 84 moves upward against the urging force of the compression coil spring 76, and moves the brake member 60 to the rotation permitted position.

Further, the clutch member 84 has rotation restricting ribs 90 which project-out further outwardly in the radial direction than the outer peripheral surface of the clutch member 84. A plurality of (six in the present exemplary embodiment) the rotation restricting ribs 90 are provided at uniform intervals in the peripheral direction of the clutch member 84, and are disposed radially as seen in plan view. The rotation restricting ribs 90 project-out further upward than the sliding-contact surface 86, so as to be spread over (be continuous with) the top end surface of the clutch member 84 around the sliding-contact surface 86 and the outer peripheral surface in a vicinity of that top end surface.

The rotation restricting ribs 90 are respectively disposed in rotation restricting grooves 82 (see FIG. 4, FIG. 8, FIG. 10 and FIG. 11) which are recessed in the inner edge portion of the boss portion 54 for the clutch. Namely, six of the rotation restricting grooves 82 are provided at uniform intervals in the peripheral direction of the boss portion 54 for the clutch, and open upward at the top end of the boss portion 54 for the clutch. In this way, the clutch member 84 can move in the vertical direction while, at the rotation restricting ribs 90 thereof, being guided by the rotation restricting grooves 82 of the boss portion 54 for the clutch.

The rotation restricting ribs 90 maintain the state of being disposed in the rotation restricting grooves 82 of the boss portion 54 for the clutch, also when the clutch member 84 moves upward and positions the brake member 60 at the rotation permitted position. In this way, the clutch member 84 cannot rotate relative to the reel 30, i.e., always rotates integrally with the reel 30. Because the rotation restricting grooves 82 are closed at the lower end portion of the boss portion 54 for the clutch, the clutch member 84 is prevented from falling-out from the reel hub 32 by the rotation restricting ribs 90 and the rotation restricting grooves 82.

Note that, as shown in FIG. 2 and FIG. 3, the rotating shaft 100 of the drive device has a rotating shaft portion 102. A disc-shaped rotating table 104 extends integrally at the top end of the rotating shaft portion 102. The driving gear 108, which can mesh-together with the reel gear 44 of the recording tape cartridge 10, is formed in an annular form at the top surface of and at the outer peripheral edge portion of the rotating table 104. Further, a magnet 106, which is substantially formed in the shape of a disc, is disposed coaxially at the top surface of the rotating table 104, at the radial direction inner side of the driving gear 108. The releasing projection 110, which abuts the pushing/operating surface 88 of the clutch member 84, is formed at the axially central portion of the rotating table 104.

Next, operation of the recording tape cartridge 10 having the reel 30 of the above-described structure will be described. At the recording tape cartridge 10, when the recording tape cartridge 10 is not in use, due to the urging force of the compression coil spring 76, the brake member 60 is positioned at the rotation locked position and causes the braking gear 66 to mesh-together with engaging gear 48. Therefore, rotation of the reel 30 with respect to the case 12 is impeded. At this time, the reel gear 44 of the reel 30 is exposed from the gear opening 20, and the clutch member 84 is inserted through the pass-through hole 50 and the through-hole 46A and faces the gear opening 20.

On the other hand, when the recording tape T is to be used, the recording tape cartridge 10 is loaded along the direction of arrow A into a bucket (not shown) of the drive device. Then, when the recording tape cartridge 10 is loaded to a predetermined depth in the bucket, the bucket is lowered, and the rotating shaft 100 of the drive device relatively approaches the gear opening 20 of the case 12 (moves upward) and holds the reel 30. Specifically, the rotating shaft 100 causes the driving gear 108 thereof to mesh together with the reel gear 44, while attracting and holding the reel plate 46 by the magnet 106 in a non-contact state.

Accompanying the meshing-together of the reel gear 44 and the driving gear 108, i.e., the relative movement of the rotating shaft 100 with respect to the case 12 in the direction of approaching the case 12 along the axial direction, the releasing projection 110 of the rotating shaft 100 abuts the pushing/operating surface 88 of the clutch member 84, and pushes the clutch member 84 upward against the urging force of the compression coil spring 76. In this way, the brake member 60, which is abutting the clutch member 84 at the sliding-contact projecting portion 68, also moves upward, and the meshing-together of the braking gear 66 of the brake member 60 and the engaging gear 48 is released.

Namely, the brake member 60 is moved to the rotation permitted position relative to the reel 30. Thereafter, when the rotating shaft 100 further moves upward relatively, the reel 30 is brought upward together with the clutch member 84 and the brake member 60 (with their relative positions remaining unchanged) against the urging force of the compression coil spring 76. The brake member 60 reaches the rotation permitted position (with respect to the case 12), and the lower flange 40 separates from the annular rib 22 (the taper surface 22A). In this way, the reel 30 rises-up within the case 12, and becomes able to rotate in a state of not contacting the inner surfaces of the case 12.

Further, at this time, due to the bucket, i.e., the recording tape cartridge 10, being lowered within the drive device, the positioning pins of the drive device enter into the positioning holes 24, 26 of the case 12 respectively, and the reference surfaces of the drive device abut the reference surfaces 24A, 26A of the case 12. In this way, the recording tape cartridge 10 is positioned in the horizontal direction and in the vertical direction with respect to the drive device. Thus, the pull-out means of the drive device, while engaging with the engaging recess 28A of the leader block 28, takes the leader block 28 out from the case 12 and guides the leader block 28 to the take-up reel of the drive device.

Then, the leader block 28 is fit into the reel hub of the take-up reel such that the arc-shaped surface 28B thereof forms a portion of the take-up surface around which the recording tape T is taken-up. In this state, when the leader block 28 rotates integrally with the take-up reel, the recording tape T is pulled-out from the case 12 through the opening 18, while being taken-up onto the reel hub of the take-up reel. Note that, at this time, the reel 30 of the recording tape cartridge 10 rotates synchronously with the take-up reel due to the rotational force of the rotating shaft 100 which is transmitted by the driving gear 108 which is meshed-together with the reel gear 44.

Then, recording of information onto the recording tape T, or playback of information recorded on the recording tape T, is carried out by a recording/playback head (not shown) which is disposed along a predetermined tape path of the drive device. Note that, at this time, the sliding-contact projecting portion 68 of the brake member 60, which cannot rotate with respect to the case 12, slidingly-contacts the sliding-contact surface 86 of the clutch member 84 which rotates together with the reel 30 with respect to the case 12. Namely, the clutch member 84 is structured such that, in the state in which the reel gear 44 is meshed-together with the driving gear 108, the state of abutment of the clutch member 84 with the releasing projection 110 at the pushing/operating surface 88 of the clutch member 84 is maintained, and the clutch member 84 holds the brake member 60 at the rotation permitted position.

Then, when the reel 30 rotates, there is no relative rotation between the clutch member 84, which rotates integrally with the reel 30, and the rotating shaft 100, which drives the reel 30, and the pushing/operating surface 88 and the releasing projection 110 do not slidingly-contact one another. The sliding-contact surface 86 of the clutch member 84 and the sliding-contact projecting portion 68 of the brake member 60, which cannot rotate with respect to the case 12, slidingly-contact one another. In this way, because there is no relative rotation between the rotating shaft portion 102 and the clutch member 84, the problem of the releasing projection 110 or the pushing/operating surface 88 becoming worn does not arise.

On the other hand, when the recording of information onto the recording tape T or the playback of information recorded on the recording tape T is finished, the recording tape T is rewound onto the reel 30, and the leader block 28 is held in a vicinity of the opening 18 of the case 12. Then, the bucket in which the recording tape cartridge 10 is loaded rises. Thus, the meshing-together of the reel gear 44 and the driving gear 108 is released, the abutment of the releasing projection 110 and the pushing/operating surface 88 of the clutch member 84 is released, and the clutch member 84 moves downward together with the brake member 60 (with the state of abutment thereof maintained) due to the urging force of the compression coil spring 76.

In this way, the braking gear 66 of the brake member 60 meshes-together with the engaging gear 48, and the brake member 60 returns to the rotating locked position at which the brake member 60 impedes rotation of the reel 30 with respect to the case 12. Further, accompanying the operation of the brake member 60 and the clutch member 84 moving due to the urging force of the compression coil spring 76, the reel 30 also moves downward. While the lower flange 40 of the reel 30 is made to abut the annular rib 22, the reel gear 44 is returned to its initial state of being exposed from the gear opening 20. In this state, the recording tape cartridge 10 is ejected from the drive device (bucket).

The structure of the mold which molds the reel relating to the exemplary embodiment of the present invention will be described next.

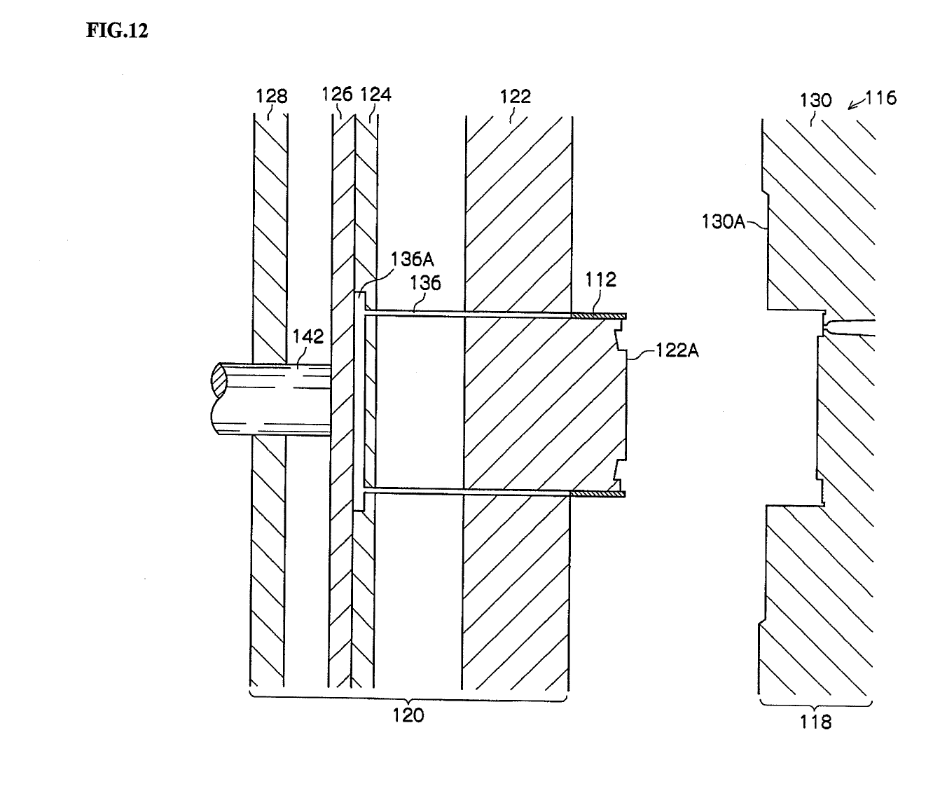

As shown in FIG. 12 through FIG. 16, a mold 116 is broadly divided into a fixed side 118 and a movable side 120. A movable side mold plate 122, ejecting plates 124, 126, and a movable side attachment plate 128 are provided at the movable side 120. A fixed side mold plate 130 and a fixed side attachment plate (not shown) are provided at the fixed side 118. Opening or closing of the mold 116 is carried out by the movable side 120 moving horizontally with respect to the fixed side 118 by an unillustrated driving means.

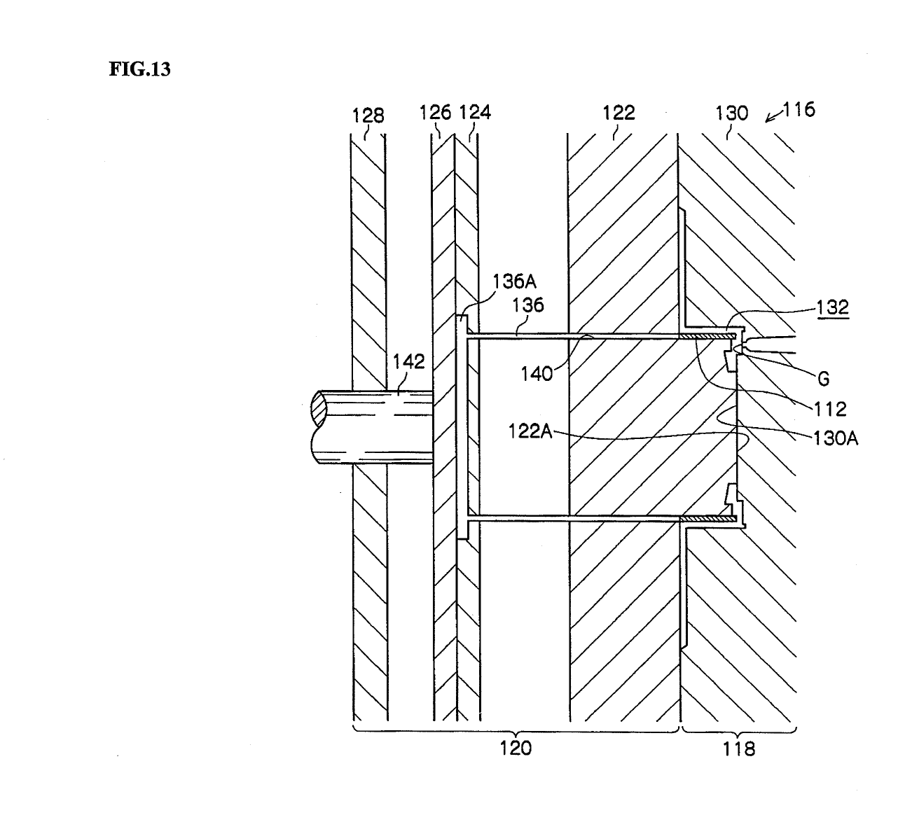

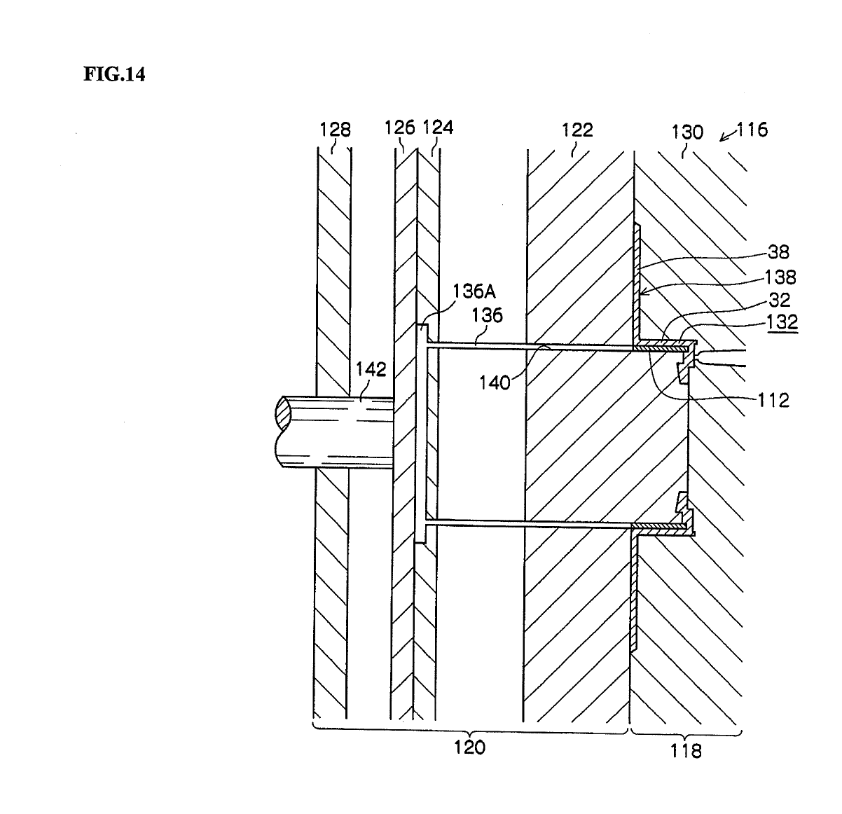

A concave portion 130A or a convex portion 122A is formed at the surface of the fixed side mold plate 130 or the movable side mold plate 122. First, in the state in which the mold 116 is opened as shown in FIG. 12, the metal ring 112 is made to engage with the convex portion 122A of the movable side mold plate 122. Then, in the state in which the mold 116 is closed as shown in FIG. 13, resin is filled through the gate G, which is provided at the fixed side mold plate 130, into a space 132 which is formed by the fixed side mold plate 130 and the movable side mold plate 122 as shown in FIG. 14. Due to solidification of this resin, the reel hub 32 and the upper flange 38 (hereinafter called “molded product 138”) are molded.

On the other hand, the ejecting plates 124, 126 are disposed between the movable side mold plate 122 and the movable side attachment plate 128. An attachment portion 136A of an annular ejecting sleeve 136 is attached to the ejecting plates 124, 126. In the state in which the mold 116 is closed, the distal end surface of the ejecting sleeve 136 abuts the entire region of the end surface of the metal ring 112. Further, an insert-through hole 140, which is annular and through which the ejecting sleeve 136 can be inserted, is formed in the movable side mold plate 122, and the ejecting sleeve 136 can move within the movable side mold plate 122.

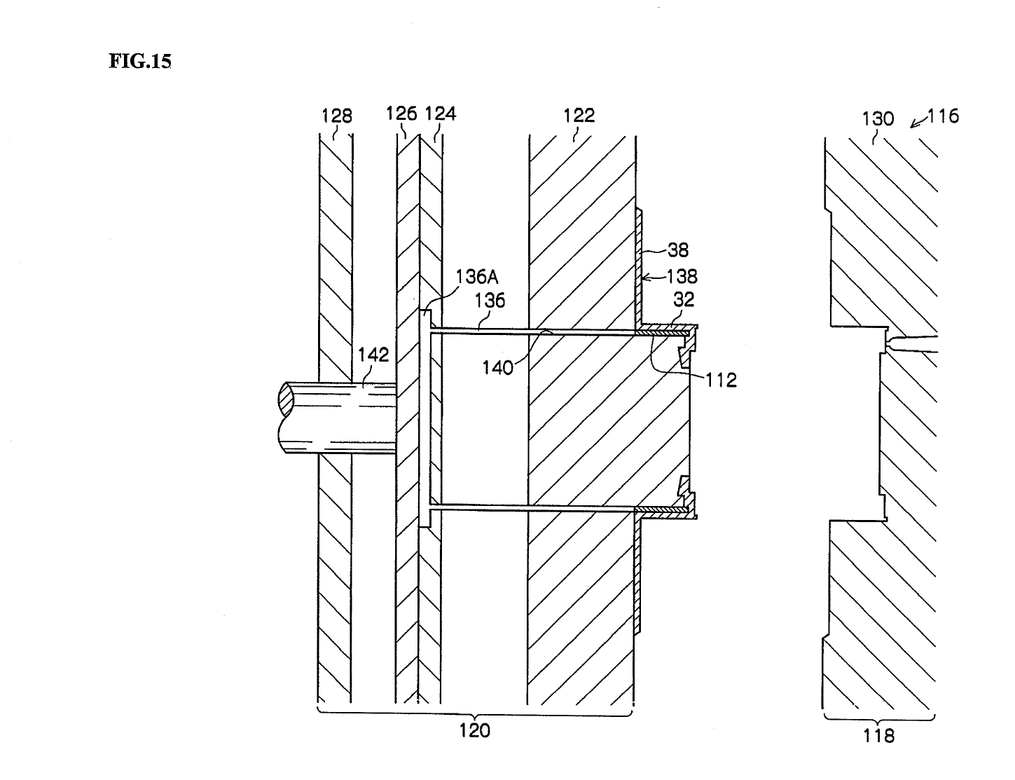

In the state in which resin has been filled within the space 132 and has become solidified, when the mold 116 is opened as shown in FIG. 15, the molded product 138 is released from the fixed side mold plate 130, and moves integrally with the movable side mold plate 122.

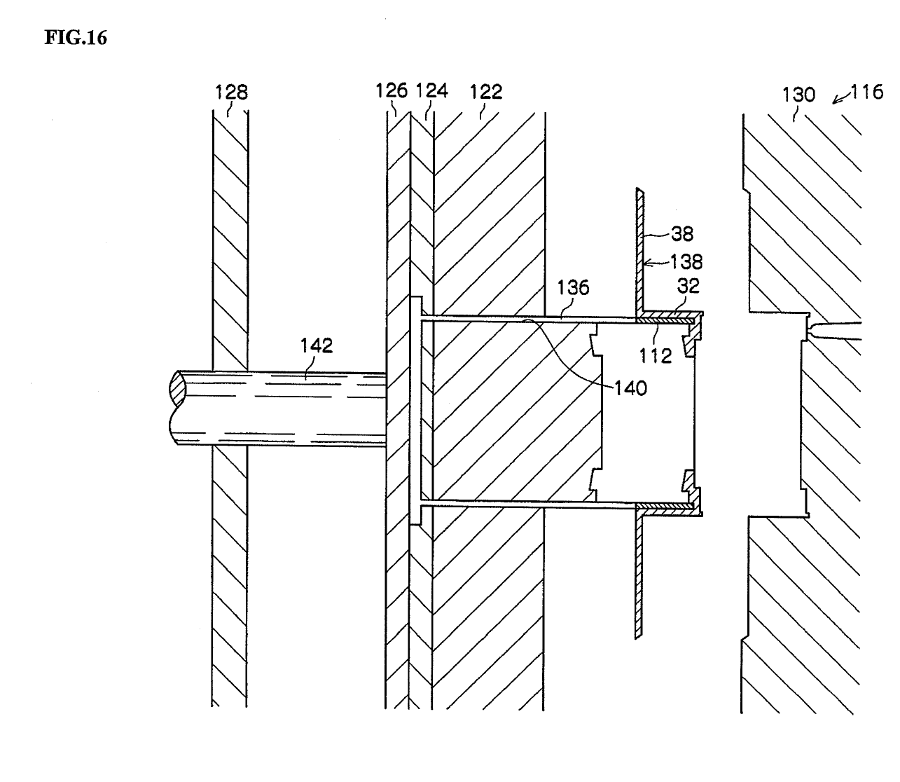

Then, as shown in FIG. 16, the ejecting plates 124, 126 are pushed by an ejecting rod 142 which is movably provided at the movable side mold plate 122. In this way, the ejecting plates 124, 126 move within the gap provided between the ejecting plate 124 and the movable side mold plate 122, the ejecting sleeve 136 moves within the insert-through hole 140 of the movable side mold plate 122, the distal end surface of the ejecting sleeve 136 pushes the entire region of the end surface of the metal ring 112 and ejects the molded product 138, and releases the molded product 138 from the movable side mold plate 122. Note that, other than the ejecting sleeve 136, there is an ejecting pin which abuts the molded product 138 and ejects the molded product 138, but description thereof will be omitted here.

In a case of carrying out insert molding by the metal ring 112, because there is little heat shrinkage at the metal ring 112 which is different than as is the case with resin, it is difficult of the molded product 138 to bite-into the movable side mold plate 122. In the state shown in FIG. 15 in which the mold 116 is opened, there are cases in which the molded product 138 remains at the fixed side mold plate 130 (so-called cavity removal defect).

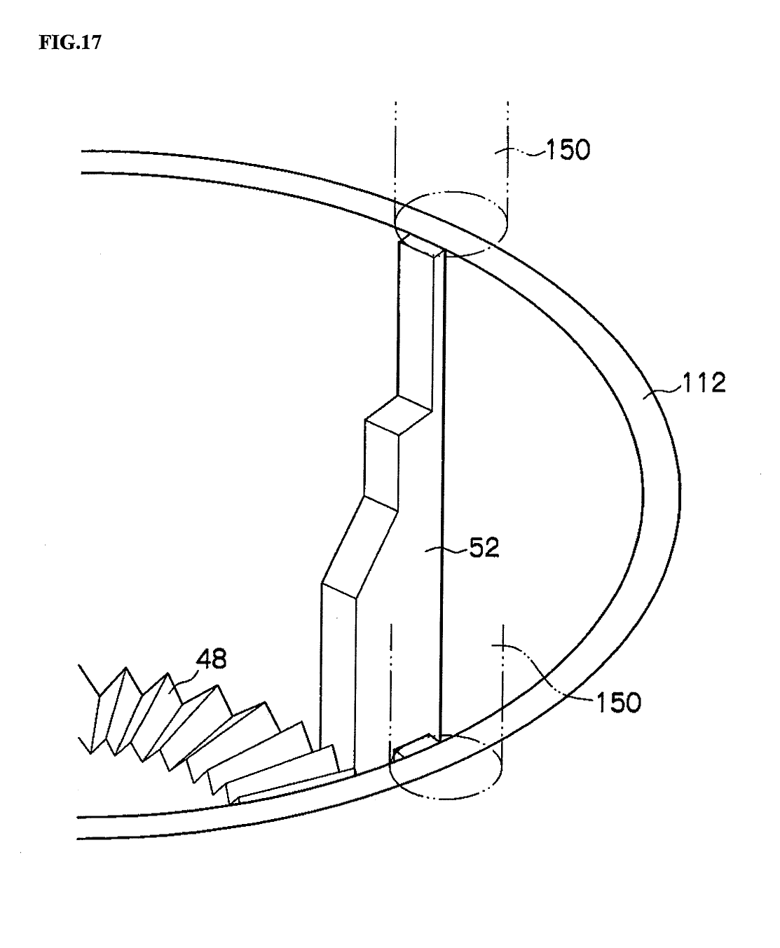

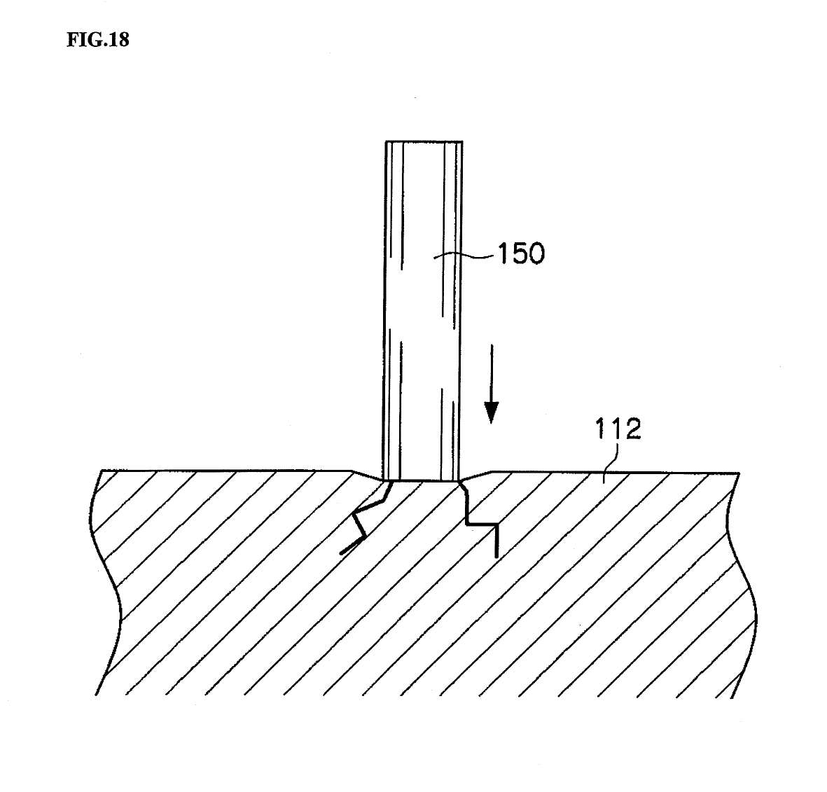

Therefore, the mold release resistance of the molded product 138 from the movable side mold plate 122 is made to be higher than that of the fixed side mold plate 130, and the molded product 138 is made to bite-into the movable side mold plate 122. However, when the molded product 138 is to be released from the movable side mold plate 122, the pushing force by ejecting pins 150 (see FIG. 17), which are for causing the molded product 138 to be released, becomes large by an amount corresponding to the amount by which the mold release resistance is made large. Large stresses are applied locally to the end surface of the metal ring 112, and, as shown in FIG. 18, there is the concern that deformation or cracking of the metal ring 112 will arise.

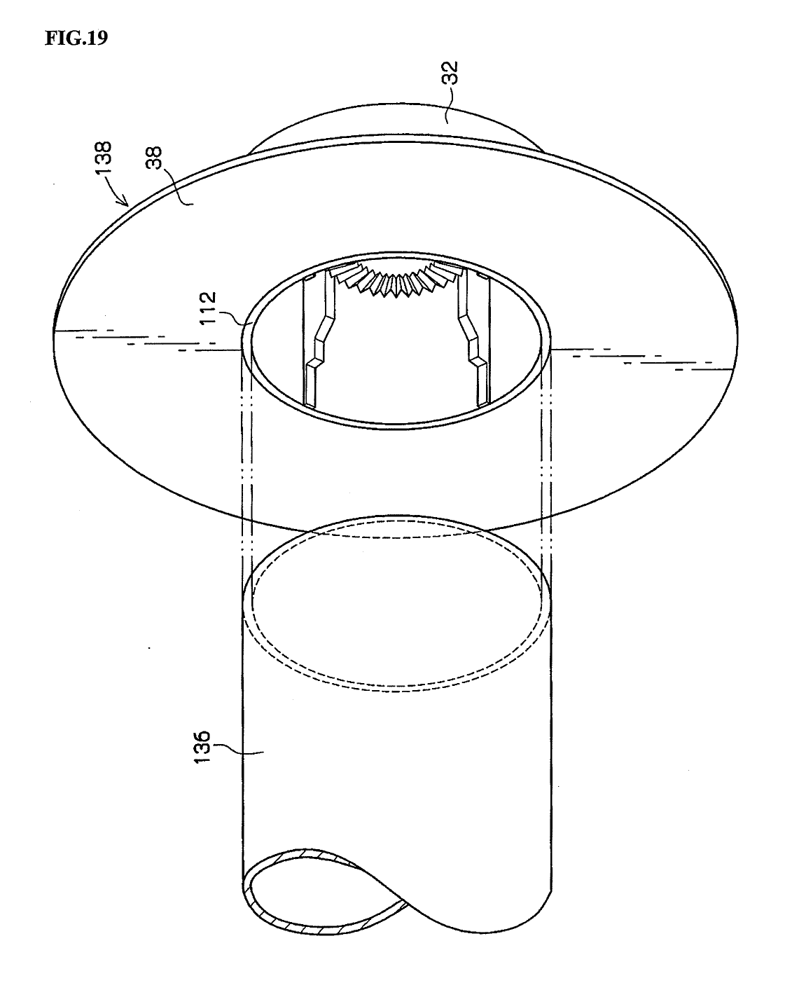

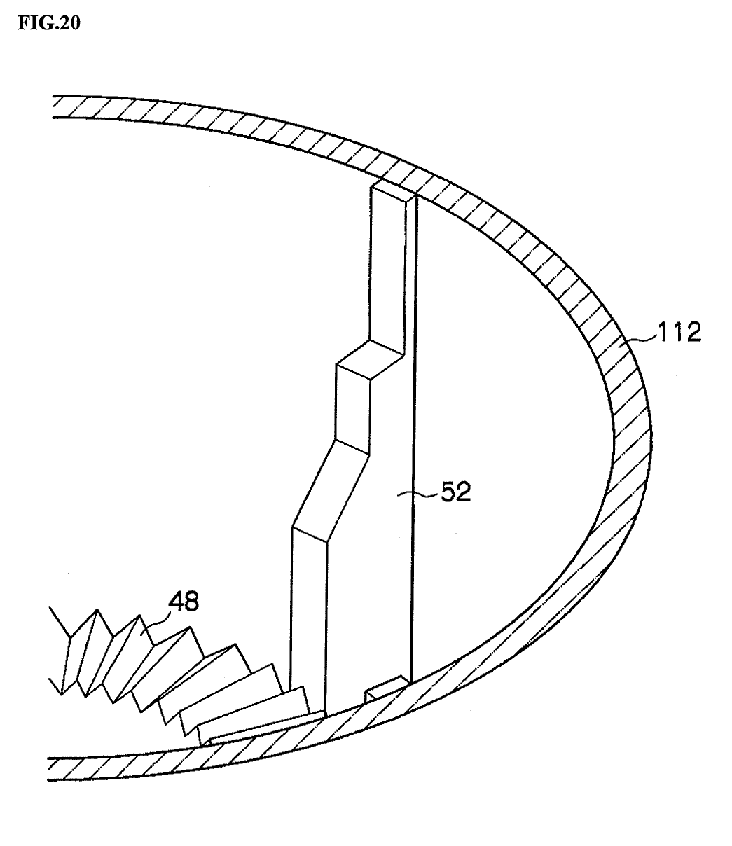

However, in accordance with the present exemplary embodiment, at the time of releasing the molded product 138, as shown in FIG. 16 and FIG. 19 (in FIG. 19, in order to illustrate the shape of the ejecting sleeve 136, a gap is provided between the distal end surface of the ejecting sleeve 136 and the end surface of the metal ring 112), the entire region of the end surface of the metal ring 112 (the region shown by hatching in FIG. 20) is pushed by the annular ejecting sleeve 136. In this way, pushing force is applied uniformly at the entire region of the end surface of the metal ring 112, and the occurrence of deformation or cracking of the metal ring 112 is suppressed.

Note that, here, the entire region of the end surface of the metal ring 112 is pushed by the ejecting sleeve 136. However, if a resin layer is provided at the end surface of the metal ring 112, the entire region of the end surface of this resin layer is pushed by the ejecting sleeve 136.

Further, the material and wall-thickness of the metal ring 112 are not limited to those described in the present exemplary embodiment, and the reinforcing ring may be a non-metal material provided that it increases the rigidity of the reel hub 32. However, if a corrosive material such as an aluminum material or the like is used for the reinforcing ring, it is desirable that the surface of the reinforcing ring be subjected to a corrosion preventing treatment such as plating or the like.

It is desirable that the aluminum material have sufficient proof stress in order for setting to not arise with respect to tight-winding of the recording tape T. In the case of the present exemplary embodiment, an aluminum material having a proof stress of 350 N/mm² is used. Further, the material of the cylindrical tube portion 34 is not limited to polycarbonate (PC) and may be another resin material which can be injection molded, provided that mechanical strength which satisfies the specifications of the reel 30 can be obtained.

Further, in the present exemplary embodiment, as shown in FIG. 10, the reel hub 32 and the upper flange 38 are molded integrally, and the reel gear 44, which meshes-together with the driving gear 108 of the drive device, is provided at the lower flange 40. However, the reel gear 44 may be provided at the reel hub 32, although such a structure is not illustrated.

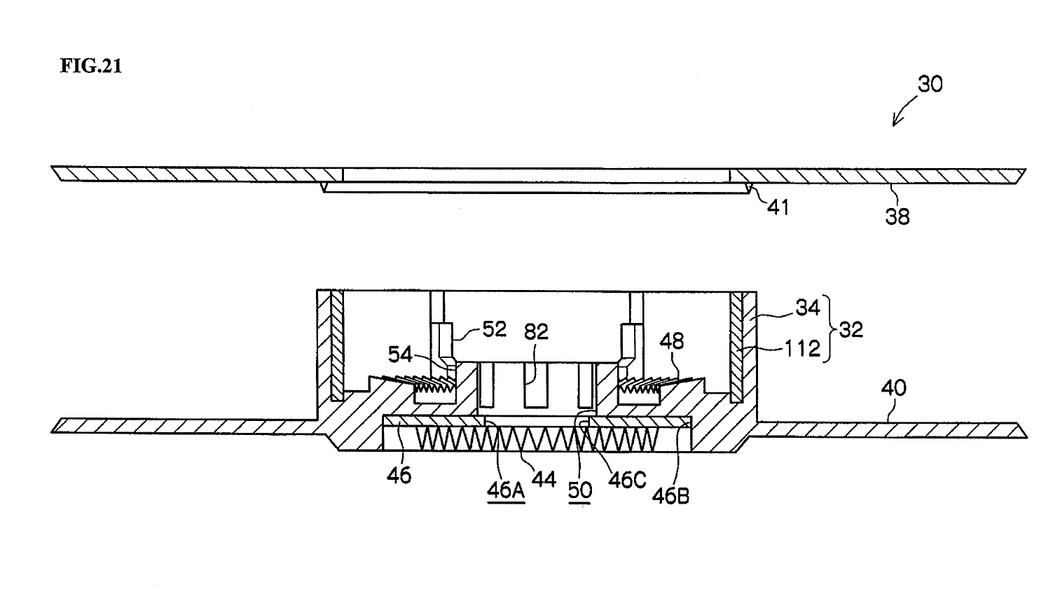

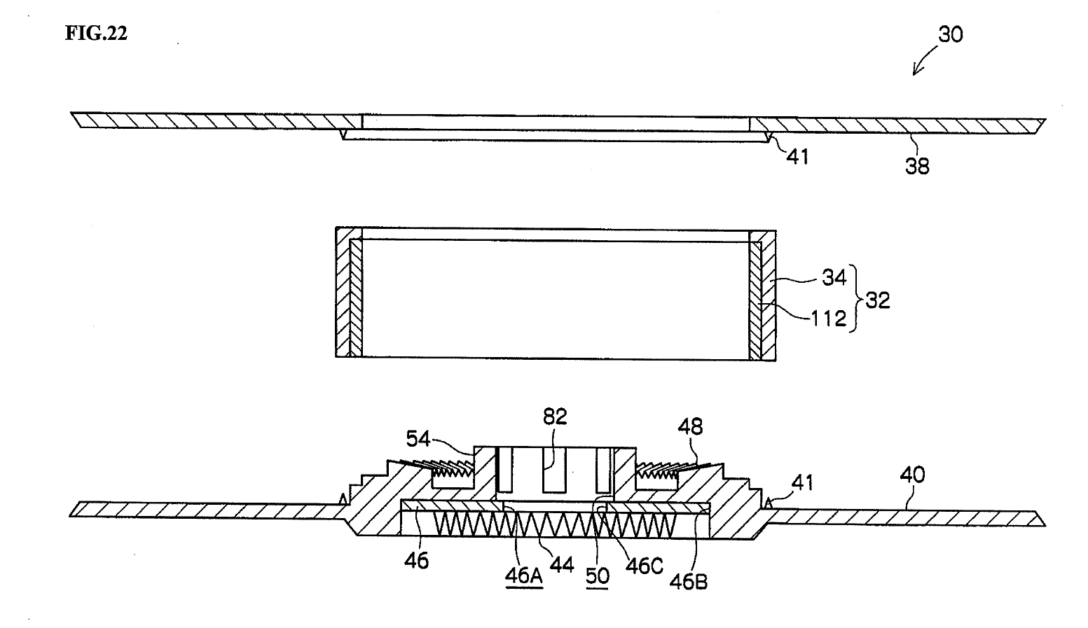

Moreover, as shown in FIG. 21, a structure in which the reel hub 32 and the lower flange 40 are molded integrally may be used. Or, the upper flange 38, the reel hub 32, and the lower flange 40 may be structured by three parts (three pieces) as shown in FIG. 22.

Here, as shown in FIG. 2, the through-hole 46A is formed for movement of the clutch member 84. However, in a type of recording tape cartridge in which the through-hole 46A is not formed, the position of the gate of the mold can be made to be the central portion of the reel hub 32, although such a structure is not illustrated. In this way, because the resin is filled into the mold by spreading radially with the gate as the center, it is difficult for weld lines (seams of the resin) or the like to arise, and the strength of the reel 30 can be improved.

Note that in the recording tape cartridge 10 of the above-described exemplary embodiment, the leader block 28 is used as the leader member. However, the recording tape cartridge 10 is not limited to the above-described exemplary embodiment. For example, the recording tape cartridge 10 may be a structure having a solid-cylindrical leader pin (not shown) as the leader member, or may be a structure having a covering member which opens and closes the opening 18 (a sliding door or the like (not shown) which moves along a predetermined straight line or circular arc). Moreover, it suffices for the recording tape T to be interpreted as an elongated-tape-shaped information recording/playback medium onto which information can be recorded and from which recorded information can be played-back. It goes without saying that the recording tape cartridge 10 (the reel 30) can be applied as well to recording tapes T of any recording/playback systems.

The above-described exemplary embodiment illustrates an example in which the reel 30 is applied to the recording tape cartridge 10 which is structured so as to accommodated a single reel within the case 12. However, the present invention is not limited to the same, and the reel 30 may be applied, for example, to a two-reel recording tape cartridge which accommodates two reels within a case.

What is claimed is:

1. A method for manufacturing a reel comprising:
reinforcing a hub on which a recording tape is wound, by providing a reinforcing ring for the hub;
wherein at a time of release from a mold which molds the hub, an entire region of an end surface of the reinforcing ring is pushed, and
providing a flange at both end portions of the hub respectively to hold transverse direction end portions of the recording tape.

2. The method according to claim 1, wherein the reinforcing ring is made from an aluminum material, the aluminum material having a proof stress of 350 N/mm².

3. A mold for molding the hub included in the reel of claim 1, comprising:
a movable side, provided with a movable side mold plate, ejecting plates and a movable side attachment plate, the ejecting plates being provided between the movable side mold plate and the movable side attachment plate;
a fixed side, provided with a fixed side mold plate with a gate and a fixed side attachment plate;
a concave portion formed at a surface of the fixed side mold plate;
a convex portion formed at a surface of the movable side mold plate; and
an ejecting rod movably provided at the movable side mold plate and pushing the ejecting plates,
wherein opening or closing of the mold is carried out by the movable side moving horizontally with respect to the fixed side,
an attachment portion of an annular ejecting sleeve is attached to the ejecting plates,
the ejecting sleeve is movable within the movable side mold plate through an insert-through hole formed in the movable side mold plate.

4. A hub molding method using the mold of claim 3, comprising:
engaging a reinforcing ring with the convex portion of the movable side mold plate in a state in which the mold is opened,
filling resin through the gate in a state in which the mold is closed,
moving the molded hub, which is formed due to solidification of the filled resin, integrally with the movable side mold plate so as to release the hub from the fixed side mold plate,
ejecting the hub by pushing the ejecting sleeve together with the ejecting plates with the ejecting rod so as to release the hub from the movable side mold plate, wherein a distal end surface of the ejecting sleeve pushes an entire region of an end surface of the reinforcing ring so as to eject the molded hub.
